(19) United States
(12) Patent Application Publication
(10) Pub. No.: US 2017/0078779 A1
(43) Pub. Date: Mar. 16, 2017

(54) CORD ACCESSORY SYSTEM

(71) Applicant: Our Ladys Table, Arroyo Grande, CA (US)

(72) Inventor: Verda Eileen Hamparson, Arroyo Grande, CA (US)

(21) Appl. No.: 14/856,530

(22) Filed: Sep. 16, 2015

(51) Int. Cl. H04R 1/10; F16L 3/11; B29C 45/00; A44C 23/00; B29C 67/00; B29C 39/02; F16L 3/10; A45F 5/00

(52) U.S. Cl. CPC H04R 1/10; F16L 3/1091; F16L 3/11; A45F 5/00; A44C 23/00; B29C 67/0051; B29C 39/02; B29C 45/00; A45F 2005/006; B33Y 80/00

(57) ABSTRACT

A system for coupling accessories to a portion of a earbud/headphone audio cord. The accessories include a central hub in two part configured to couple to and enclose a portion of the earbud/headphone cord, a loop coupled to a top of the cord and configured to be worn over a head of a user, and a tail coupled to a bottom portion of the hub.

### FIELD OF THE INVENTION

The present invention relates generally to accessories attached to a headphone or earbud cord.

### DISCUSSION OF THE RELATED ART

Headphone assemblies are articles of manufacture that include a pair of small loudspeakers which are designed to be held in place close to a user's ears, and typically include, a pair a wires which allow the loudspeakers to be connected via an input plug into a jack of an audio signal source, such as an audio amplifier, a radio, a CD/DVD player, a portable media player, a computer, a tablet, a smartphone, a video game console, and like audio sources. In-ear versions are commonly known as earphones or earbuds. If a microphone is added, the resulting combination is commonly known as a headset. Headphone assemblies are generally used to prevent other people from hearing the sounds broadcast by the loudspeakers, either for privacy or to prevent disturbance to others, as in listening in a public library. Headphone assemblies can also provide a level of sound fidelity greater than room loudspeakers of similar cost.

As advantageous as such headphone assemblies are, many users desire to uniquely express themselves through, and/or individualize, their audio equipment. For example, protective cases for portable music players/smartphones have long been available in different colors and/or overlain by decals and/or imprinted with various words, designs, corporate logos, and like indicia, such as licensed images relating to a user's favorite sports team or music group. As another example, headphone assemblies may be sold with designs on the exterior of the earbuds.

“Headphones” are generally comprised of a pair of transducers placed in close proximity to a person's ears. The transducers receive an electrical signal from a media player or a receiver and use speakers to convert the signal into audible sound waves. The use of headphones began with the inventions of the telephone and radio, as sensitive headphones were about the only way to detect some of the weaker electrical signals produced by those early instruments.

Headphones are still in use today, being commonly known as earphones, earbuds, stereophones, and headsets. Most wired headphones/earbuds in use today are configured to attach to and receiving signals from media players and receivers through a jack plug. Head phones may also be configured for additional attachments such as USB or to connect a microphone jack. Players and receivers such as smartphones, digital music players, computers, video game consoles, and tablets, among other devices, commonly use wired headphones/earbuds.

Often, headphones/earbuds are used in order to prevent other people from hearing the sound output from the media player or receiver. Headphone/earbuds may also produce a sound quality that is different than many other types of speakers. Wearing a pair of headphones/earbuds may also provide an ergonomic effect by allowing a wearer use of his or her hands while the person is wearing the headphones/earbuds.

As advantageous as such headphones are, many users desire to uniquely express themselves through, and/or individualize, their audio equipment. For example, protective cases for digital music players/smartphones have long been available in different colors and/or overlain by decals and/or imprinted with various words, designs, corporate logos, and like indicia, such as licensed images relating to a user's favorite sports team or music group. As another example, headphone assemblies may be sold with designs on the exterior of the earbuds. Small objects may be attached to a portion of the headphone cord.

### SUMMARY OF THE INVENTION

Several embodiments of the invention advantageously address the needs above as well as other needs by providing a cord accessory comprising: a hub comprising: is first part including a first outside face with an ornamental design and it first inside face, and a first continuous perimeter rim around a perimeter of the first part; and a second part configured to removably couple to the first part, the second part including a second outside face and a second inside face, and a second continuous perimeter rim around a perimeter of the second part, the second perimeter rim including at least two notches; a loop wherein a portion of the loop is coupled to one of the first perimeter rim and the second perimeter rim; and a tail coupled to one of the first perimeter rim and the second perimeter rim such that the tail extends away from the hub, whereby the hub is configured to couple to a cord having a first end and a second end by coupling the first part to the second part such that the first outside face and the second outside face form an exterior of the hub, a portion of the cord is enclosed within the hub and the first cord end and the second cord end each pass through one notch.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a front view of a cord accessory coupled to a set of earbuds in accordance with one embodiment of the present invention.

FIG. 2 is a front view of a person wearing the set of earbuds coupled to the cord accessory.

FIG. 3 is a front view of a hub portion of the cord accessory coupled to a lead cord.

FIG. 4 is a front view of a first part of a hub of the cord accessory.

FIG. 5 is a rear view of the first part of the hub of the cord accessory.

FIG. 6 is a view of the right side of the first part of the hub of the cord accessory.

FIG. 7 is a front view of a second part of the hub of the cord accessory, with the lead cord.

FIG. 8 is a rear view of a second part of the hub of the cord accessory, with the lead cord.

FIG. 9 is a view of the top of the second part of the hub of the cord accessory, with the lead cord.

FIG. 10 is an elevational view of the top of the hub with the first part coupled to the second part, with the lead cord.

FIG. 11 is a is a front view of a hub portion of the cord accessory, coupled to the earbud set in another embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these an embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

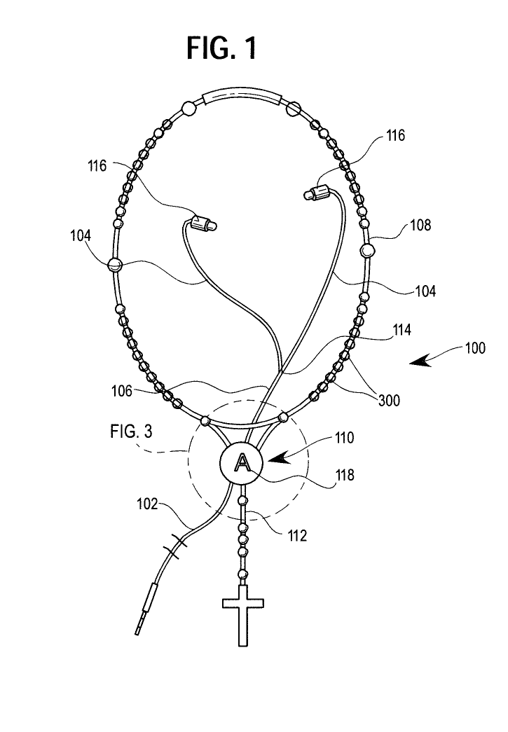

Referring first to FIG. 1, a plan view of an exemplary cord accessory 100 is shown coupled to a set of earbuds 102 in accordance with one embodiment of the present invention. Shown are the cord accessory 100, the earbud set 102, two ear cords 104, a lead cord 106, a cord accessory loop 108, a cord accessory hub 110, a cord accessory tail 112, a Y-junction 114, two earbuds 116, an ornamental design 118, and a plurality of beads 300.

The cord accessory 100 generally composes the central hub 110, with the loop 108 comprising a loop element coupled to the hub 110 at one portion of the loop 108 and extending away from the hub 110. The tail 112 coupled to a portion of the hub 110 generally opposite to where the loop 108 is coupled to the hub 110, and extends away from the hub 110 in a direction generally opposite to the loop 108. As shown in FIG. 1, the cord accessory 100 is configured in the shape of a rosary, with the loop 108 forming the necklace portion of the rosary and including beads 300 coupled to the loop 108 and spaced along the loop 108. The loop 108 may be configured to fit over a head of a user or may include a clasp, hook, latch or other removable coupling. The hub 110 and the tail 112 form a lower portion of the rosary, with the tail 112 comprising a linear cord portion with heads 300 coupled to the cord and a crucifix coupled to an end of the tail 112 distal to the hub 110. The hub 110 may include the ornamental design 118 on an outside face of the hub 110. The exemplary ornamental design 118 shown is a decorative initial, but may include a bas-relief picture, monogram, lettering, or any other decorative design. In some embodiments a 3-D object may be coupled to the outside face of the hub 110.

The cord accessory 100 is shown coupled to the exemplary set of earbuds 102, but it will be understood that any type of head-worn audio equipment with at least one cord may be used, for example, headphones, a headset, or earphones.

The exemplary hub 110 is generally disk-shaped and comprised of a first part 400 and a second part 700 coupled to the first part 400 and enclosing a portion of the least cord, as described further below. The hub 110 is generally 1.5″-3″ in diameter and ½-3″ in thickness. The hub 110 may be made by 3D printing, injection molding, casting, or any other type of suitable manufacture. The hub 110 is generally comprised of polyurethane plastic but may comprise silicone, glass, plastic, clothe, metal, jewel, clay or any other suitable material. The loop 108 and the tail 112 may comprise polyurethane plastic, silicone, glass, plastic, clothe, metal, jewel, clay or any other suitable material. The hub 110 may be of any shape that is configured to couple the first part 400 to the second part 700 around a portion of the headphone cord, and described further below.

The loop 108 and the tail 112 may be formed by 3D printing, injection molding, casting or any other type of suitable manufacture. In some embodiments the loop 108 and tail 112 are integrally formed with at least one portion of the hub 110. In other embodiments, the hub parts 400, 700, the loop 108 and the tail 112 are formed separately and the loop 108 and the tail 112 are coupled to the hub 110 at a later point. In some embodiments the loop 108 and tail 112 are formed in a multi-part process, for example, a cord portion of the loop 108 is formed, then later bead portions are formed around the cord portion. In some embodiments the cord portion and the bead portions comprise different materials. For example, the cord may have an embedded wire to provide additional support.

As shown in FIG. 1, the cord accessory 100 is coupled to the set of earbuds 102 such that the cord accessory 100 passes through the hub 110 and is coupled to the hub 110. The earbud set 102 comprises the lower lead cord 106, which connects to an audio device 202. The lead cord 106 splits into the upper earphone cords at the Y-junction 114. The ear cords 104 terminate in the earbuds 116. While the set of earbuds 102 is shown, it will be understood that any audio device supported by the head of the user may be used, e.g. headsets, headphones, or earphones.

The cord accessory 100 is coupled to the lead cord 106 below the Y-junction 114, or, in some instances, at the Y-junction 114. As described further below, the hub 110 is coupled to the lead cord 106, or to the lead cord 106 and the ear cords 104, such that the loop 108 extends upwards and is proximate to the earphone cords, and the tail 112 extends downwards, away from the loop 108.

The hub 110, loop 108 and tail 112 in the embodiment of FIG. 1 are in the shape of a rosary, but it will be understood by those of ordinary skill in the art that other shapes and/or items may be used for the hub 110, loop 108, and/or tail 112, including but not limited to medals, jewels, beads, wires, cords, chains, snaps, enclosures, hooks, jewelry, charms, lights, cases necklaces, and toys. Materials used may include but are not limited to metal, plastic, glass, and fabric.

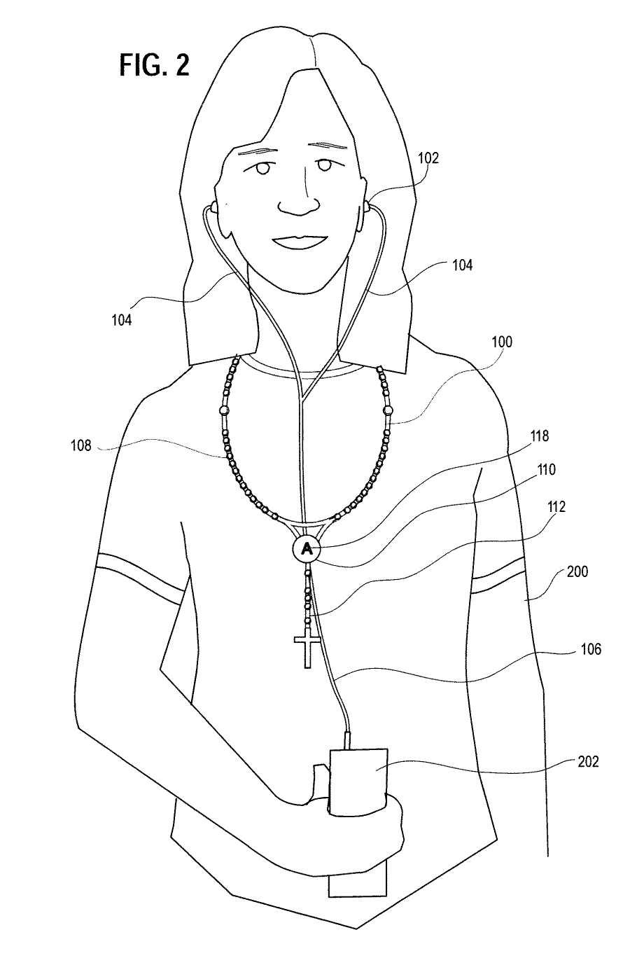

Referring next to FIG. 2, the exemplary cord accessory 100 is shown as worn by an exemplary user 200. Shown are the cord accessory 100, the earbud set 102, the ear cords 104, the lead cord 106, the loop 108, the hub 110, the tail 112, the Y-junction 114, the earbuds 116, the user 200, and the audio device 202.

The user 200 is wearing the set of earbuds 102, with the earbuds 116 of the set of earbuds 102 coupled to the ears of the user 200 and the ear cords 104 extending downward to the Y-junction 114, where the lead cord 106 continues extending downward and terminates at a connection to the exemplary audio device 202 which is being held by the user 200. The hub 110 has been coupled to the lead wire such that the hub 110 rests generally against the chest of the user 200, with the outside face including the ornamental design 118 facing outward. The loop 108 is placed over the head of the user 200, such that the loop 108 functions generally as a necklace. The tail 112 extends downward from the hub 110. In some embodiments the cord accessory 100 is supported on a neck of the user 200 and the lead cord 106 may slide within the hub 110. In other embodiments the hub 110 is configured to clamp to or otherwise be attached to and supported by the lead cord 106.

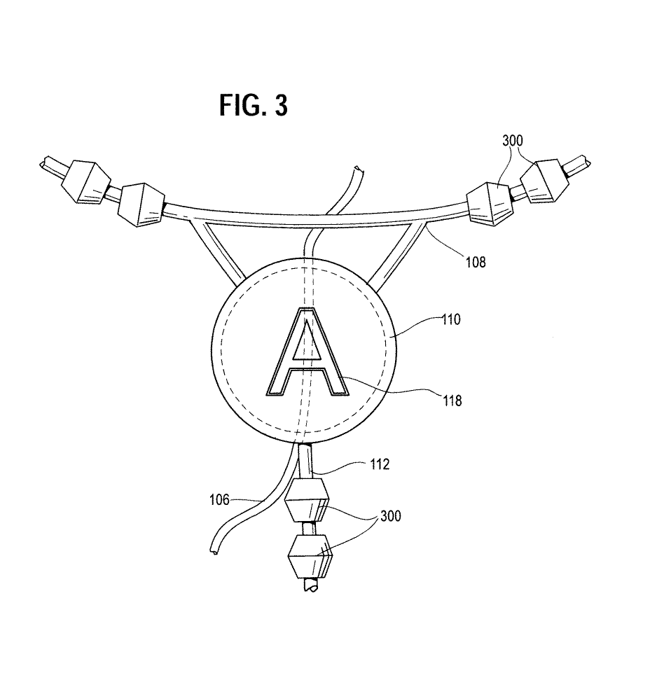

Referring next to FIG. 3, a detail of a portion of the cord accessory 100 coupled to the cord is shown. Shown are the lead cord 106, the loop 108, the hub 110, the tail 112, the ornamental design 118, and the plurality of beads 300.

The loop 108 is coupled to the hub 110 using two stems connecting the continuous loop element to the hub 110. In the embodiment shown, an end of the stem proximate to the loop 108 is formed integrally with the loop 108. An end of the stem proximate to the hub 110 fits within the loop notch 408 in the hub 110 and is coupled to the hub 110 using an adhesive or other method. Alternate methods of connecting the loop 108 to the hub 110 may be used, for example a single stem or a connection using one or more rings. In some embodiments, the stem end proximate to the hub 110 may be formed integrally with the hub 110.

A portion of the lead cord 106 is coupled to and enclosed by the hub 110. The lead cord 106 is shown exiting a top portion and a bottom portion of the hub 110, but the hub 110 may be configured to allow the lead cord 106 to exit at alternate hub 110 locations, or multiple exit locations may be provided in a single hub 110.

The tail 112 is coupled to the bottom portion and extends downward from the hub 110. The tail 112 is shown coupled to the hub 110 by an end of the tail 112 proximate to the hub 110 fitting within a tail notch 410 in the hub 110 and coupled by an adhesive or other method. As with the loop 108, other connection types may he used.

Beads 300 are shown coupled to the tail 112 and the loop 108. The beads 300 may be integrally formed with the tail 112 and/or loop 108, or may be added after the formation of the tail 112 or loop 108. The beads 300 may be of any bead shape, for example faceted, round, square, paddle, or cylindrical. In other embodiments the loop 108 and/or the tail 112 lack beads.

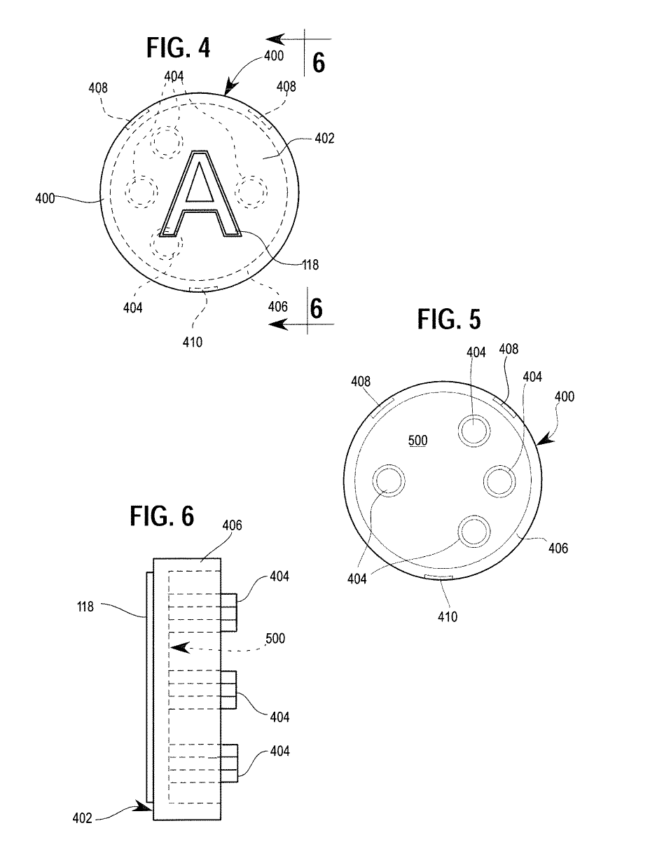

Referring next to FIGS. 4, 5 and 6, elevational and side views of the first part 400 of the hub 110 are shown. A front view of the first part 400 is shown in FIG. 4. A rear view of the first part 400 is shown in FIG. 5. A side view of the first part 400 is shown in FIG. 6. Shown are the ornamental design 118, a first outside face 402, a plurality of tubes 404, a first perimeter rim 406, two loop notches 408, the tail notch 410, and a first inside face 500.

The first part 400 of the hub 110 is generally disk-shaped and includes the first outside face 402 and the first inside face 500. The first outside face 402 includes the ornamental design 118. The first perimeter rim 406 is generally perpendicular to the first inside face 500 and extends continuously outward from the first inside face 500.

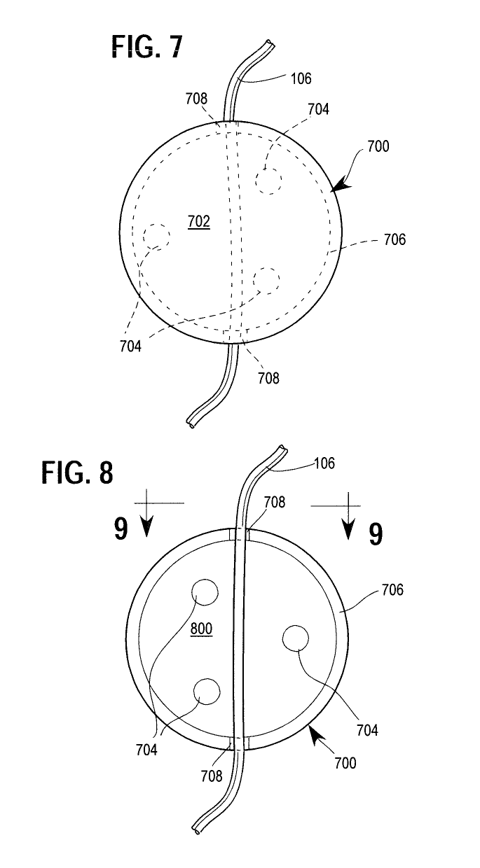

In the embodiment shown, the first part 400 also includes the plurality of tubes 404 integrally formed with and extending outward from and normal to the first inside face 500. The tubes 404 extend past the perimeter rim, as shown in FIG. 6. Tube 404 length is as required to couple with the pins 704, or as required for other types of coupling. Tube locations are configured to match locations of pins 704 of the hub 110 second part 700, as described further below. The tube locations are also located to allow the cord to pass between the tubes 404 when the first part 400 is coupled to the second part 700 of the hub 110, as described further below in FIGS. 7, 8 and 9.

In the embodiment shown, the hub 110 includes the loop notches 408 and the tail notch 410 for coupling the loop 108 and the tail 112 to the hub 110 as previously described in FIG. 3. In other embodiments the loop 108 and tail 112 may be connection to the second part 700 only, or to both the first part 400 and the second part 700 of the hub 110.

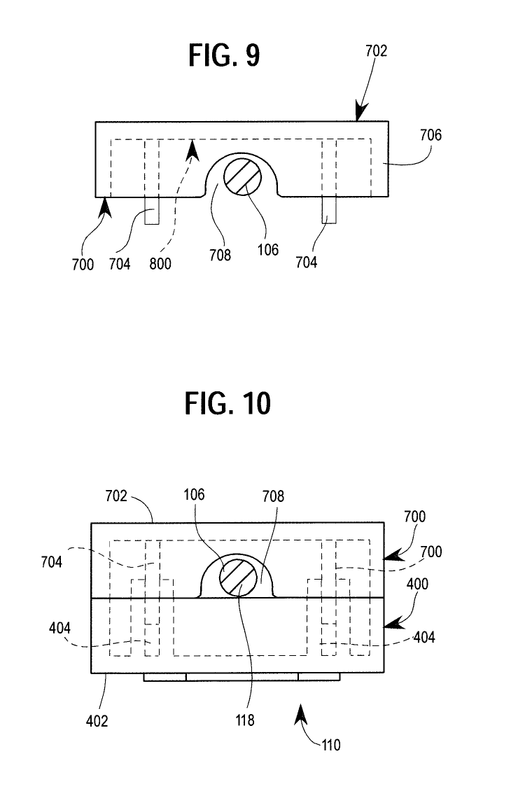

Referring next to FIGS. 7, 8 and 9, elevational and side views of the second part 700 of the hub 110 are shown along with the lead cord 106. A front view of a of the second part 700 is shown in FIG. 7. A rear view of the second part 700 is shown in FIG. 8. A top view of the second part 700 is shown in FIG. 9. Shown are the lead cord 106, a second outside face 702, the plurality of pins 704, a second perimeter rim 706, at least two cord notches 708, and a second inside face 800.

The second part 700 is generally a mirror element to the first part 400, with the exception that the second part 700 includes pins 704 in lieu of tubes 404, includes at least two cord notches 708 in the second perimeter rim 706, and the second part 700 lacks the ornamental design 118 on the second outside thee 702, although an ornamental design on the second outside face 702 may be included in some embodiments. The second perimeter rim 706 is generally perpendicular to the second inside face 800 and extends continuously outward from the second inside face 800. The generally cylindrical pins 704 extend outward and are generally normal to the second inside face 800. A length of the pins 704 may vary depending on the hub dimensions, but is generally long enough to provide the friction fit coupling (or other type of coupling) with the tubes 404. The pins 704 are located and configured to slide within the tubes 404 of the first part 400 and provide a friction fit when the first perimeter rim 406 is juxtaposed with the second perimeter rim 706, coupling the first part 400 to the second part 700 to form the hub 110. In other embodiments the first part 400 may be coupled to the second part 700 by a clamping portion, snap fit, or any other type of removable coupling. The cord notches 708 are located generally at the top and bottom of the second part 700, and are configured to allow the lead cord 106 to pass through the cord notches 708 when the first part 400 is coupled to the second part 700.

The coupling of the first part 400 to the second part 700 is shown further below in FIG. 10.

Referring next to FIG. 10, a top view of the hub 110 is shown with the first part 400 coupled to the second part 700 and the lead cord 106 passing through and coupled to the hub 110. Connections to the loop 108 are not shown for clarity. Shown are the lead cord 106, the ornamental design 118, the first part 400, the first outside face 402, a plurality of tubes 404, the second part 700, the second outside face 702, a plurality of puts 704, and one of the cord notches 708.

The headphone cord is coupled to the hub 110 by first locating the lead cord 106 in the cord notches 708 as shown in FIGS. 7-9, then aligning the tubes 404 with the pins 704 and pressing the first part 400 to the second part 700 so that the first perimeter rim 406 meets the second perimeter rim 706, thus forming the hub shape with the first outside face 402 and the second outside face 702 facing outwards in opposite directions. In some embodiments the first part 400 and the second part 700 may also be hinged together at one side.

In the embodiment shown, the coupled hub 110 forms a general disk shape, with the first perimeter rim 406 and the second perimeter rim 706 aligning. Other hub shapes may be used, for example a rectangular, hexagonal, and irregular shape, or any 3D shape configured to couple to the lead cord 106 as previously described.

In the embodiment shown, four tubes 404 are included in the first part 400, and three pins 704 are included in the second part 700, with three of the tubes 404 aligning with the three pins 704 that are generally located at the corners of an equilateral triangle. The equilateral triangle spacing provides multi-directional connections (as opposed to only two connections aligned in a single direction) while still leaving enough space for the lead cord 106 to fit between the connections. While in the present embodiment four tubes 404 and three pins 704 are shown, it will be understood by those of ordinary skill in the art that varying numbers and locations of pins 704 and tubes 404 may be used. In some embodiments the numbers of pins 704 and tubes 404 are equal, with each pin 704 fitting into one corresponding tube 404.

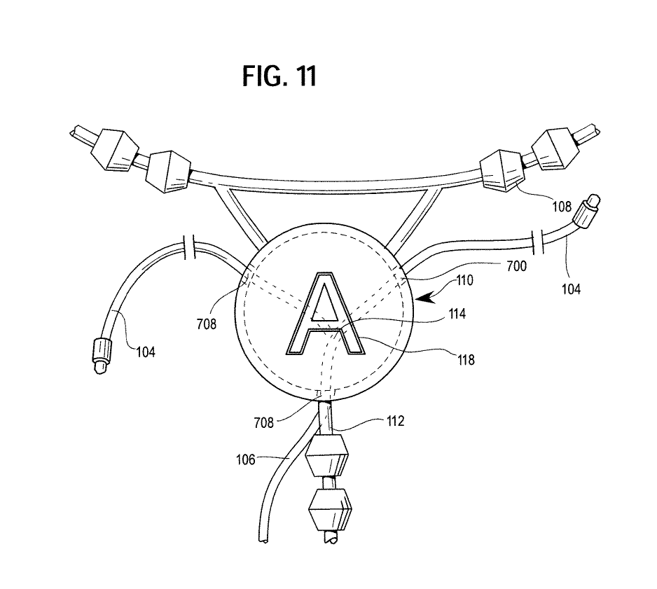

Referring next to FIG. 11, Referring next to FIG. 3, a detail of the hub portion of the cord accessory 100 coupled to the cord is shown in accordance with an alternate embodiment of the invention. Shown are two ear cords 104, the lead cord 106, loop 108, the hub 110, the tail 112, the Y-junction 114, the ornamental design 118, and three cord notches 708.

In the embodiment shown in FIG. 11, the hub 110 has been configured to include the Y-junction 114 of the earbud set 102 within the hub 110, instead of the only the lead cord 106 as previously described. The second part 700 includes three cord notches 708, corresponding to the locations of the headphone cords as they exit the Y-junction 114: one notch 708 at a bottom of the second part 700 for the lead cord 106, one notch 708 at a top-right location for one ear cord 104, and one notch 708 at a top-left location for the other ear cord 104. The tubes 404 and pins 704 are not shown for clarity, but would be located to provide coupling of the first part 400 to the second part 700 while still avoiding the path of the cords inside the hub 110.

While the invention herein disclosed has been described by means of specific embodiments, examples and applications thereof, numerous modifications and variations could be made thereto by those skilled in the art without departing from the scope of the invention set forth in the claims.

What is claimed is:

1. A cord accessory comprising:
a hub comprising:
a first part including a first outside face with an ornamental design and a first inside face, and a first continuous perimeter rim around a perimeter of the first part; and
a second part configured to removably couple to the first part, the second part including a second outside face and a second inside face, and a second continuous perimeter rim around a perimeter of the second part, the second perimeter rim including at least two notches;
a loop wherein a portion of the loop is coupled to one of the first perimeter rim and the second perimeter rim; and
a tail coupled to one of the first perimeter rim and the second perimeter rim such that the tail extends away from the hub, whereby the hub is configured to couple to a cord having a first end and a second end by coupling the first part to the second part such that the first outside face and the second outside face form an exterior of the hub, a portion of the cord is enclosed within the hub and the first end and the second end each pass through one notch.

2. The cord accessory of claim 1 wherein the cord is a cord for a listening device.

3. The cord accessory of claim 1 wherein the portion of the cord enclosed within the hub is a lead cord.

4. The cord accessory of claim 1 wherein the hub is generally a disk shape.

5. The cord accessory of claim 1, wherein the hub is formed using at least one of 3D printing, casting, and injection molding.

6. The cord accessory of claim 1, wherein the loop and the tail are formed using at least one of 3D printing, casting, and injection molding.

7. The cord accessory of claim 1, wherein the removable coupling of the first part to the second part is a friction coupling.

8. The cord accessory of claim 7, wherein the first inside face includes at least one tube normal to the first inside face, and wherein the second inside face includes at least one pin normal to the second inside face, whereby the at least one pin is configured to friction fit within the at least one tube, whereby the first part is friction fit to the second part.

9. The cord accessory of claim 1, wherein the ornamental design is a bas-relief design.

10. The cord accessory of claim 1, the second perimeter rim including three notches.

11. The cord accessory of claim 10, wherein the cord has a third end passing through one of the three notches.

12. The cord accessory of claim 10, wherein the cord includes a Y-junction, and wherein the portion of the cord enclosed within the hub includes the Y-junction.

13. The cord accessory of claim 12, wherein the cord is one of a listening device.

14. The cord accessory of claim 1, wherein the loop is configured to fit over a head of a user.

15. The cord accessory of claim 14, wherein the loop includes beads coupled to the mop.

16. The cord accessory of claim 15, wherein the beads are of size, shape and spacing of rosary beads.

17. The cord accessory of claim 1, wherein the hub, loop and tail form a rosary.

18. The cord accessory of claim 1, wherein the tail includes beads coupled to the tail.

19. The cord accessory of claim 1, wherein the tail forms a portion of a rosary.
